(19) United States
(12) Patent Application Publication
(10) Pub. No.: US 2013/0036588 A1
(43) Pub. Date: Feb. 14, 2013

(54) Method and Apparatus for Installing a Device at a Storage Vessel

(71) Applicants: Joram Agar, Grand Cayman (KY); David Farchy, Bellaire, TX (US)

(72) Inventors: Joram Agar, Grand Cayman (KY); David Farchy, Bellaire, TX (US)

(73) Assignee: AGAR CORPORATION LIMITED, Grand Cayman (KY)

(21) Appl. No.: 13/206,287

(22) Filed: Aug. 9, 2011

(51) Int. Cl. B23P 11/00

(52) U.S. Cl. 29/428

(57) ABSTRACT

A method and apparatus for installing a device in a storage vessel having a drawline while the storage vessel is in operation is disclosed. A cutting tool is run through the drawline from a distal location to a location inside the storage vessel. The cutting tool is used to create an opening in the drawline at the location inside the storage vessel. The device is installed at the created opening.

### BACKGROUND OF THE DISCLOSURE

1. Field of the Disclosure

This application relates generally to storage vessels and to apparatus and methods for installing a device in vessels containing two non-amicable fluids.

2. Description of the Related Art

Storage vessels containing hydrocarbons, crude oil, feed-stocks, intermediates and finished products accumulate water over time at the bottom of the vessels. Standard industry practice is to periodically drain the water from the vessel. Automatic vessel de-watering is also used to drain water. In automatic systems, an interface detector probe and a shut-off valve are installed in a drawline at a location outside the tank. This system is susceptible to oil spillage due to time delay between oil detection in the drawline and shutting off of the control valve. Accumulated water then traps the oil in the drawline, thus requiring a manual restart and subsequent oil spillage. For existing storage vessels, the probe can be installed at a wall of the tank using a welding process known as hot-tapping, which process can be hazardous, dangerous and cumbersome. In addition, once a hot-tapping process is completed, the tank needs to be recertified by regulatory authorities. The present disclosure provides a method for installing a device, such as a detector probe, inside a storage vessel that avoids hot-tapping, improves safety, reduces pollution and can be performed without the need for recertification of the tank.

### SUMMARY OF THE DISCLOSURE

In one aspect, the present disclosure provides a method and apparatus for installing a device in a storage vessel having a drawline while the storage vessel is in operation. In one method, a cutting tool is run through the drawline from a distal location to a location inside the storage vessel. The cutting tool is used to create an opening in the drawline at the location inside the storage vessel. The device is installed at the created opening.

In another aspect, the present disclosure provides an apparatus for installing a device in a storage vessel, the apparatus including: a member configured to run through an existing drawline in the storage vessel from a distal location to a location inside the storage vessel; and a cutting tool at an end of the member configured to create an opening in the drawline at the location inside the storage vessel; wherein the device is installed at the created opening.

In another aspect, the present disclosure provides a drilling tool that includes a pilot bit configured to drill a hole of a first size; a drill bit following the pilot, the drill bit configured to drill a hole of a second size that is larger that the first size; and a saw following the drill bit, the saw configured to cut a hole of a third size that is larger than the second size.

In another aspect, the present disclosure provides a drilling apparatus that includes a drilling tool to cut holes in objects inside vessels through existing entrances.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description, taken in conjunction with the accompanying drawings, in which like elements have generally been given like numerals and wherein:

FIG. 1 (Prior Art) shows an exemplary section of a storage vessel that includes a drawline for discharging water from the storage vessel;

FIG. 2 illustrates an exemplary drilling assembly for creating an opening in a drawline of the storage vessel according to one embodiment of the disclosure;

FIG. 3 shows an exemplary apparatus installed in the created opening of FIG. 2 according to an exemplary embodiment of the disclosure;

FIG. 4 shows an exemplary storage vessel system having a device installed therein according to the methods described herein for discharging a fluid from the exemplary storage vessel system;

FIG. 5 shows a flowchart illustrating an exemplary method of installing a device in a storage vessel tank via the drawline, according to one embodiment of the present disclosure; and

FIG. 6 shows a detailed view of a cutting tool of the exemplary drilling assembly of FIG. 2.

### DETAILED DESCRIPTION OF THE DISCLOSURE

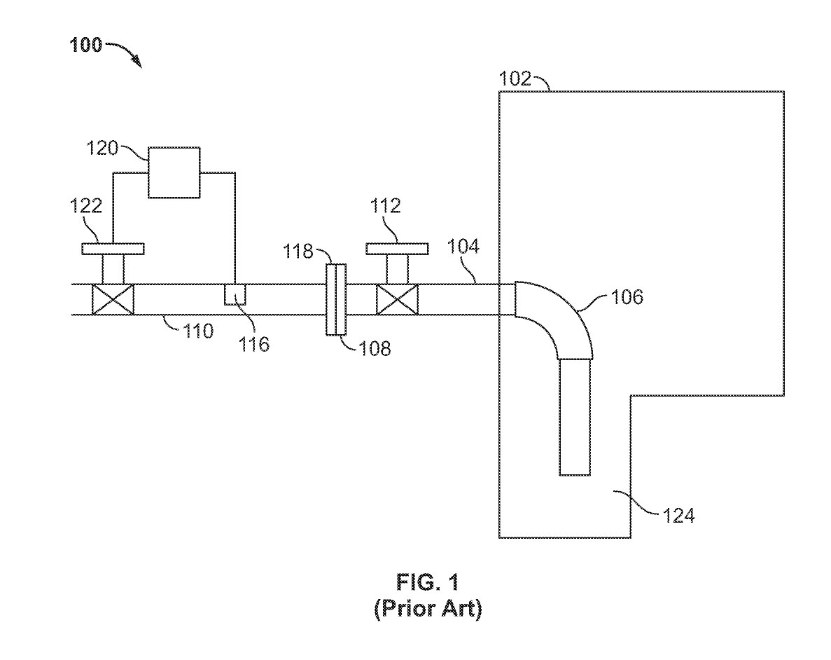

FIG. 1 (Prior Art) shows a system 100 including a storage vessel 102 having a drawline 104 for discharging water from the storage vessel. In an exemplary embodiment, the storage vessel unit 102 may be a tank for storing oil or other hydrocarbons. Drawline 104 connects to storage vessel 102 via a flow device such as block valve 112 and traverses through a wall of the storage vessel 102. Inside the storage vessel 102, drawline 104 has an elbow section 106 that directs the drawline downward towards sump 124. Sump 124 collects fluid such as water that is to be drained from the storage vessel 102. Block valve 112, can be opened to drain the fluid from the sump 124 and closed to prevent the fluid from flowing out. A secondary line 110 for delivery of the fluid to a destination location is coupled to the drawline 104 via flanges 108 and 118. Secondary line 110 includes a control valve 122 and probe 116 installed in the secondary line. A control unit 120 is coupled to the control valve 122 and the probe 116. When the probe 116 detects hydrocarbons in the secondary line, a signal is sent to the control unit 120, which in turn closes the control valve 122.

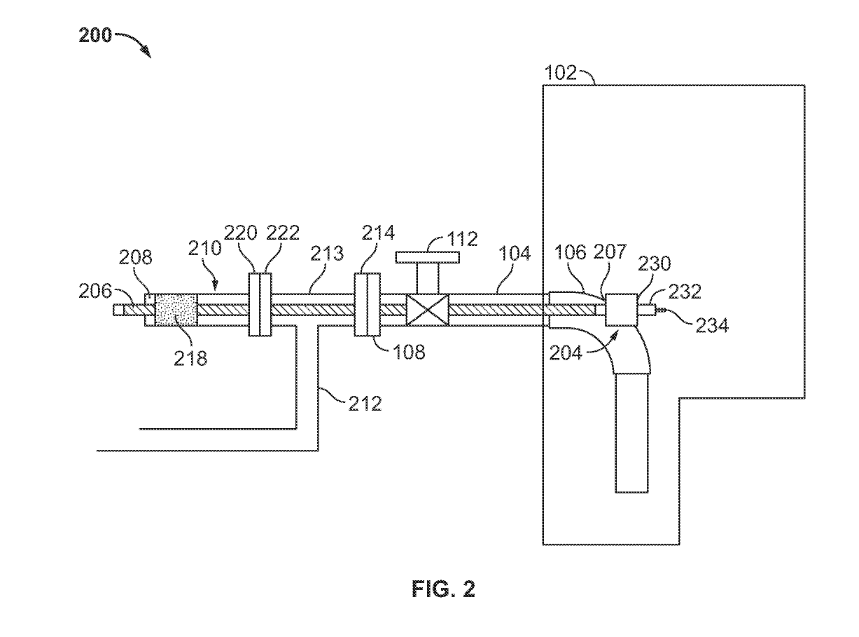

FIG. 2 illustrates an exemplary apparatus for creating an opening in the drawline of FIG. 1 for installation of a device in an exemplary embodiment. Secondary line 110 of FIG. 1 is removed from the drawline 104 and installation line 213 is then coupled to drawline 104 via flanges 214 and 108. A drilling assembly 210 is coupled to installation line 213 via flanges 220 and 222. A bypass line 212 is coupled to drilling line 213 to allow fluid flow to be redirected while the drilling assembly 210 is in place. The drilling assembly 210 is then used to drill an opening in the elbow 106. The drilling assembly 210 includes a seal housing 208 and a shaft 206 that includes a cutting tool 204 coupled to an end of the shaft. The cutting tool 204 includes a saw 230 a drill 232 and a pilot bit 234.

FIG. 6 shows a detailed view of the cutting tool (also referred to as a drilling tool) 204 of the drilling assembly. Cutting tool size decreases from saw 230 to drill bit 232 to pilot bit 234. In a particular typical embodiment, the saw 230 may be about 2 inches in diameter, the drill 232 about ½ of an inch in diameter and the pilot bit 234 about ⅛ of an inch in diameter. The saw, drill bit and the pilot bit may have other suitable sizes. In general, the pilot bit 234 drills a first opening in the non-planar section of the drawline. The drill 232 then drills a second opening that widens the first opening drilled by the pilot bit 234. The pilot bit 234 supports the drill bit 232 when the drill bit engages the non-planar section of the drawline to enable the drill bit 232 to drill the opening in a straight line. The saw 230 then drills a third opening that widens the second opening drilled by the drill bit 232. The drill bit 232 supports that saw 230 when the saw engages the non-planar section of the drawline to enable the saw to drill the opening along a straight line. The cutting tool 204 is therefore designed to create an opening at a curved or non-planar portion of the drawline 104, such as the elbow 106. Although the cutting tool 204 is described herein as using drill bits, any tool capable of creating an opening in the drawline 104 may be used in alternate embodiments of the present disclosure.

Returning to FIG. 2, the shaft 206 is mounted within the seal housing 208 and is configured to slide along an axial direction of the seal housing. The drilling assembly 210 is first coupled to the drawline with the cutting tool 204 in a generally retracted position within or near the seal housing 208. The seal housing 208 seals the installation line 213 and enables drilling a hole at a location inside the storage vessel 102 without spilling a liquid, such as hydrocarbons, stored in the storage vessel. The seal housing 208 further enables drilling and installation of equipment in situ or without having to either drain the storage vessel prior to drilling or shut down other processes during drilling. Block valve 112 is opened and the shaft 206 is run via installation line 213, valve 112 and the drawline 104 to position the cutting tool 204 at elbow 106, as shown in FIG. 2. The cutting tool 204 can then be operated to create opening 207 in the elbow 106 of drawline 104. A motor 218 coupled to the shaft 206 may be used to rotate the cutting tool 204 to create the opening in the drawline. The motor 218 is shown inside the seal housing 208 in FIG. 2. However, the motor can be located at any suitable location along the shaft, including at a location proximate the cutting tool. In addition, any method of rotating the cutting tool may be used, including a ratchet or hand-operated device. The cutting tool may include a stabilizer (not shown) for maintaining a position of the cutting tool 204 in order to create the opening at a consistent location of the elbow 106, that is typically a non-planar surface. Once the opening 207 is created, shaft 206 and cutting tool 204 may be retracted so that the cutting tool 204 is returned to the seal housing 208 of the drilling assembly 210. The drilling assembly 210 may then be removed from the installation line 213. The depicted drilling assembly 210 provides an arrangement for providing an opening in the elbow 106 without puncturing or affecting the storage vessel 102, thereby enabling a monitoring device to be installed in the drawline 104 in situ without draining the vessel or taking the vessel off line.

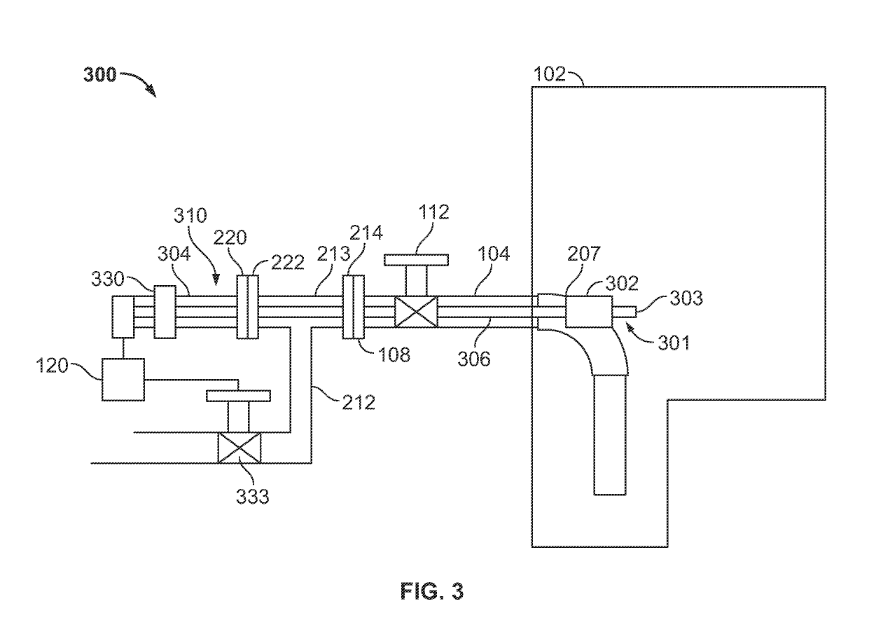

FIG. 3 shows an exemplary apparatus 300 for controlling flow of a fluid from the storage vessel, wherein a probe or device 301 has been placed or installed in a storage vessel 102 according one embodiment of the disclosure. The flow control apparatus 300 includes the device 301 installed in the storage vessel 102 via the drawline 104. In the particular embodiment of FIG. 3, the device 301 is installed at the opening 207 created using the drilling assembly 210 (FIG. 2). The device 301 includes a seal portion 302 configured to seal the opening 207. The seal portion 302 is typically any suitable geometry, such as a conical section, made of Teflon. The device 301 also includes an active portion 303 that performs the detection function of the device. In various embodiments, the device 301 may include, but is not limited to, a detector configured to provide information relating to an interface between two dissimilar fluids in the storage vessel; a detector configured to provide information relating to a chemical property of the fluid in the storage vessel; a detector configured to provide information relating to an electrical property of the fluid in the storage vessel; and a detector. In other embodiments, the device 301 may be a pump configured to pump the fluid into or from the storage vessel or a cleaning device configured to clean inside of the storage vessel.

The particular embodiment of FIG. 3 is achieved by replacing the drilling assembly 210 from the installation line 213 with device installation assembly 310. For example, the device installation assembly reduces or prevents leakage of hydrocarbons from the storage vessel 102 during installation. The installation line 213 couples to the installation assembly 310 via a coupling comprising flanges 220 and 222. The device installation assembly 310 includes a seal housing 304 that includes a communication link 306 and the device 301 as well as a cap end 330 including communication circuitry. Seal housing 304 reduces or prevents liquid spillage from the storage vessel 102 during operation of the device 301.

Communication link 306 provides communication between the device 301 and the cap end 330. The communication link 306 typically extends from the device 301 to the cap end 330 through the interior of the drawline 104. Control unit 120 is coupled to the communication circuitry of cap end 330 and receives signals from the device 301 indicative of a characteristic of a fluid in the storage vessel, such as a level of an interface between two dissimilar fluids in the storage vessel. In aspects, the control unit 120 may be configured to: receive information in the form of signals from the device and processes such received signals to estimate a property of the fluid in the storage vessel 102; control an operation of a control valve 333 in the bypass line 212 to control fluid flow in the drawline and bypass line 212 based on the estimate property of the fluid; and control an operation of the device 301, such as a cleaning operation, pumping operation, etc. as the case may be. In one aspect, the control unit 120 may be a computer-based unit that includes a processor, such a microprocessor, a data storage device, such a memory device and programs accessible to the processor for processing information from the device 301 and for controlling the operation of the device 301, control valve 333 and other devices that may be installed in the system 300.

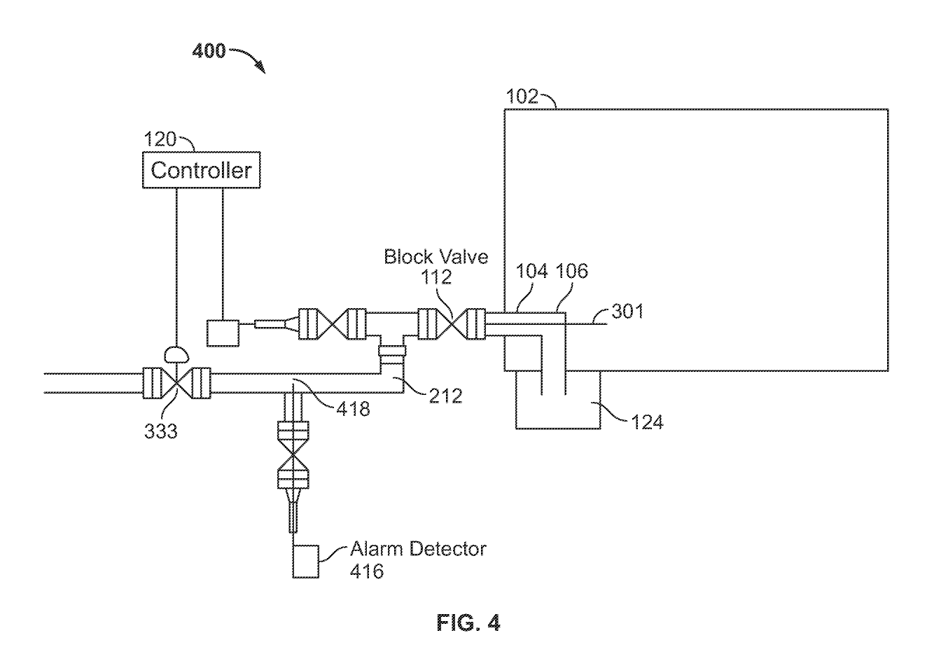

FIG. 4 shows an exemplary storage vessel system 400 having a device installed therein for discharging a fluid from the exemplary storage vessel system. The exemplary storage vessel system includes a storage vessel 102, drawline 104 and exemplary device 301 installed in the drawline 104. The device 301 can be a probe. The storage vessel 102 includes a sump 124 for collecting water that typically accumulates in the storage vessel tank. The drawline 104 is configured to remove a fluid, such as the accumulated water, from the storage vessel unit 114 and/or from sump 124. The drawline includes a flow device such as block valve 112. Elbow 106 in the drawline 104 directs the drawline 104 downwards towards the sump 124 for fluid intake. Device 301 is generally installed in the drawline 104 at a location above the sump 124. Device 301 is typically installed at the elbow 106 of drawline 104 but may be installed in the drawline at any suitable location. Device 301 is typically configured to measure a property of a fluid in the storage vessel, such as a mechanical, electrical or chemical property. In one embodiment, device 301 measures an oil/water interface. Additional functions of device 301 not enumerated herein are nonetheless contemplated by this disclosure.

The exemplary storage vessel system 400 further includes a control unit 120 configured to operate a dewatering process using measurements obtained at device 301. In an exemplary embodiment, the device 301 obtains a measurement indicating a height of an oil/water interface. As the water is removed from the sump 124, the height of the oil/water interface decreases. When the oil-water interface measurement obtained at device 301 indicates that the oil/water interface is at or below a first selected height, the control unit may close control valve 333 to prevent drawing oil and/or hydrocarbons into the drawline 104. When the oil-water interface measurement indicates that the oil/water interface is above a second selected height, the control unit may open control valve 333 to allow water to be drained from the sump 124. The first selected height may be the same as the second selected height or may be a different height.

Installation line 213 further includes an alarm detector 416 having probe 418 inserted in the installation line. The alarm detector 416 may be used to detect a presence of hydrocarbons in the installation line 213. The control valve 333 may be closed when the alarm detector 416 detects hydrocarbons in the installation line 213. In one embodiment, the control unit 120 receives an alarm signal from the alarm probe 416 and closes the control valve 333 upon receipt of the alarm signal.

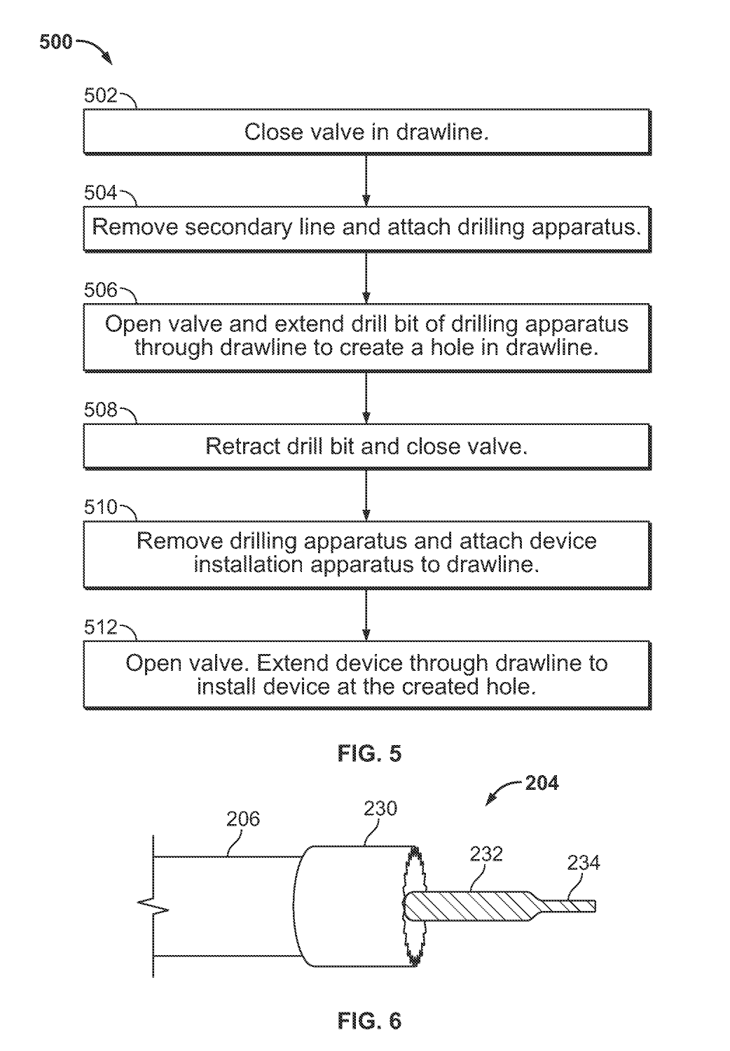

FIG. 5 shows a flowchart 500 illustrating an exemplary method of installing a device in the drawline of the present disclosure. The valve 112 in the drawline is closed (Box 502). In Box 504, secondary line 110 is detached from the drawline 104 and the installation line 213 and drilling assembly 210 are coupled to the drawline 104. In Box 506, the valve 112 is opened and the cutting tool 204 of the drilling assembly 210 is run through the interior of the drawline 104 to create an opening 207 in the drawline, generally at the elbow 106 of the drawline. In Box 508, the cutting tool 204 is retracted into the seal housing 208 of the drilling assembly 210 and the valve 112 is closed. In Box 510, the drilling assembly 210 is removed from the installation line 213 and the installation assembly 310 is coupled to the installation line 213. In Box 512, the valve 112 is opened and the device 301 is run through the interior of the drawline for installation at the opening 207 created (in Box 506) by the drilling assembly 210.

Therefore, in one aspect, the present disclosure provides a method of installing a device in a storage vessel while the tank is in operation (in situ) and having a drawline, including: running a cutting tool through the drawline from a distal location to a location inside the storage vessel; using the cutting tool to create an opening in the drawline at the location inside the storage vessel; and installing the device at the created opening. Installing the device generally includes running the device through the drawline from the distal location to the created hole. The opening may be created at a non-planar section of the drawline. Wherein the drawline includes a flow device for controlling a flow of the fluid from the storage vessel, the method further includes running the cutting tool through the flow device. The device may be installed at a location over a sump of the storage vessel. An installation line may be coupled to the drawline, wherein the cutting tool is run through the installation line. The Drawing line typically includes a control valve, and controller may be coupled to the installed device that performs a function selected from a group consisting of: (i) receiving information in the form of signals from the installed device and processing such received signals to estimate a property of a fluid in the storage vessel; and (ii) controlling an operation of the control valve. In various embodiments, device is selected from a group consisting of: (i) a detector configured to provide information relating to an interface between two dissimilar fluids in the storage unit; (ii) a detector configured to provide information relating to a chemical property of the fluid in the storage unit; (iii) a detector configured to provide information relating to an electrical property of the fluid in the storage unit; and (iv) a detector configured to provide information relating to a physical property of the fluid in the storage unit. The device may also be selected from a group consisting of: (i) a pump configured to pump the fluid into or from the storage unit; and (ii) a cleaning device configured to clean inside of the storage unit.

In another aspect, the present disclosure provides an apparatus for installing a device in a storage vessel, the apparatus including: a member configured to run through an existing drawline in the storage vessel from a distal location to a location inside the storage vessel; and a cutting tool at an end of the member configured to create an opening in the drawline at the location inside the storage vessel; wherein the device is installed at the created opening. The device is configured to run through the drawline from the distal location to the created hole. The cutting tool is further configured to create the opening at a non-planar section of the drawline. The drawline may further include a flow device for controlling a flow of the fluid from the storage vessel, wherein the member is configured to run through the flow device. An installation line may be coupled to the drawline, wherein the member is configured to run through the installation line. Wherein the installation line includes a control valve, a control unit may be used to perform a function selected from a group consisting of: (i) receiving information in the form of signals from the device and process such received signals to estimate a property of the fluid in the storage unit; and (ii) controlling an operation of the control valve. In one embodiment, the device installed at the created opening includes a communication link. In various embodiments, the device is selected from a group consisting of: (i) a detector configured to provide information relating to an interface between two dissimilar fluids in the storage unit; (ii) a detector configured to provide information relating to a chemical property of the fluid in the storage unit; (iii) a detector configured to provide information relating to an electrical property of the fluid in the storage unit; and (iv) a detector configured to provide information relating to a physical property of the fluid in the storage unit. The device may also be selected from a group consisting of: (i) a pump configured to pump the fluid into or from the storage unit; and (ii) a cleaning device configured to clean inside of the storage unit. The cutting tool typically includes a pilot bit configured to create a first hole, a drill bit configured to create a second hole after the first hole and a saw configured to create a third hole after the second hole. The pilot bit is provides support to the drill bit during drilling of the second hole, and the drill bit provides support to the saw during drilling of the third hole.

In another aspect, the present disclosure provides a drilling tool that includes a pilot bit configured to drill a hole of a first size; a drill bit following the pilot, the drill bit configured to drill a hole of a second size that is larger that the first size; and a saw following the drill bit, the saw configured to cut a hole of a third size that is larger than the second size. The drill bit provides support to the saw when the saw engages an angled surface to enable the saw to cut a hole in the angled member along a substantially straight line.

In another aspect, the present disclosure provides a drilling apparatus that includes a drilling tool to cut a hole in an object inside a vessel through an existing entrance. The drilling apparatus may include a seal housing configured to prevent a liquid inside the vessel from being spilled while the drilling tool cuts the hole.

While the foregoing disclosure is directed to certain exemplary embodiments of the disclosure, various modifications will be apparent to those skilled in the art. It is intended that all variations within the scope and spirit of the appended claims be embraced by the foregoing disclosure.

1. A method of installing a device in a storage vessel having a drawline, comprising:
running a cutting tool through the drawline from a distal location to a location inside the storage vessel;
using the cutting tool to create an opening in the drawline at the location inside the storage vessel; and
installing the device at the created opening.

2. The method of claim 1, wherein installing the device further comprises running the device through the drawline from the distal location to the created hole.

3. The method of claim 1, wherein the drawline includes a non-planar section, further comprising creating the opening at the non-planar section of the drawline.

4. The method of claim 1, wherein the drawline includes a flow device for controlling a flow of the fluid from the storage vessel, further comprising running the cutting tool through the flow device.

5. The method of claim 1, further comprising installing the device at a location over a sump of the storage vessel.

6. The method of claim 1, wherein the drawline includes a seal-housing, the method further comprising: (i) enabling the cutting of the opening via the seal-housing while preventing spillage from the storage vessel; (ii) coupling an installation line to the drawline; and (iii) running the cutting tool through the installation line.

7. The method of claim 6, wherein the installation line is coupled to a bypass line that includes a control valve, further comprising coupling a controller to the installed device that performs a function selected from a group consisting of: (i) receiving information in the form of signals from the installed device and processing such received signals to estimate a property of a fluid in the storage vessel; and (ii) controlling an operation of the control valve.

8. The method of claim 1, wherein the device is selected from a group consisting of: (i) a detector configured to provide information relating to an interface between two dissimilar fluids in the storage unit; (ii) a detector configured to provide information relating to a chemical property of the fluid in the storage unit; (iii) a detector configured to provide information relating to an electrical property of the fluid in the storage unit; and (iv) a detector configured to provide information relating to a physical property of the fluid in the storage unit.

9. The method of claim 1, wherein the device is selected from a group consisting of: (i) a pump configured to pump the fluid into or from the storage unit; and (ii) a cleaning device configured to clean inside of the storage unit.

10. An apparatus for installing a device in a storage vessel in situ, comprising:
a member configured to run through an existing drawline in the storage vessel from a distal location to a location inside the storage vessel; and
a cutting tool at an end of the member configured to create an opening in the drawline at the location inside the storage vessel;
wherein the device is installed at the created opening.

11. The apparatus of claim 10, wherein the device is configured to run through the drawline from the distal location to the created opening in the drawline, wherein the member runs through a seal-housing into the drawline, wherein the seal-housing enables drilling via the seal-housing while preventing spillage from the storage vessel.

12. The apparatus of claim 10, wherein the draw line includes a non-planar section and wherein the cutting tool is further configured to create the opening at the non-planar section.

13. The apparatus of claim 10, wherein the drawline further comprises a flow device for controlling a flow of the fluid from the storage vessel, wherein the member is configured to run through the flow device and a seal-housing into the drawline.

14. The apparatus of claim 10, further comprising an installation line coupled to the drawline, wherein the member is configured to run through the installation line.

15. The apparatus of claim 10, wherein the installation line is coupled to a bypass line includes a control valve, further comprising a control unit configured to perform a function selected from a group consisting of: (i) receiving information in the form of signals from the device and process such received signals to estimate a property of the fluid in the storage unit;
and (ii) controlling an operation of the control valve.

16. The apparatus of claim 10, wherein the device installed at the created opening includes a communication link.

17. The apparatus of claim 10, wherein the device is selected from a group consisting of: (i) a detector configured to provide information relating to an interface between two dissimilar fluids in the storage unit; (ii) a detector configured to provide information relating to a chemical property of the fluid in the storage unit; (iii) a detector configured to provide information relating to an electrical property of the fluid in the storage unit; and (iv) a detector configured to provide information relating to a physical property of the fluid in the storage unit.

18. The apparatus of claim 10, wherein the device is selected from a group consisting of: (i) a pump configured to pump the fluid into or from the storage unit; and (ii) a cleaning device configured to clean inside of the storage unit.

19. The apparatus of claim 10, wherein the cutting tool includes a pilot bit configured to create a first hole, a drill bit configured to create a second hole after the first hole and a saw configured to create a third hole after the second hole.

20. The apparatus of claim 19, wherein the reamer bit is configured to provide support to the pilot bit during drilling of a first hole and wherein the saw is configured to provide support to the reamer drill during drilling of the second hole.

21. A drilling tool, comprising:
a pilot bit configured to drill a hole of a first size;
a drill bit following the pilot bit, the drill bit configured to drill a hole of a second size that is larger that the first size; and
a saw following the drill bit, the saw configured to cut a hole of a third size that is larger than the second size.

22. The drilling tool of claim 21, wherein drill bit provides support to the saw when the saw engages an angled surface to enable the saw to cut a hole in the angled member along a substantially straight line.

23. A drilling apparatus, comprising a drilling tool configured to cut a hole in an object inside a vessel through an existing entrance while the vessel is in operation.

24. The drilling apparatus of claim 23, further comprising a seal-housing configured to prevent a liquid inside the vessel from being spilled while the drilling tool cuts the hole.

25. The method of claim 1 further comprising installing the device while the storage vessel is in operation.
